(19) United States
(12) Patent Application Publication
(10) Pub. No.: US 2026/0145064 A1
(43) Pub. Date: May 28, 2026

(54) SMART MICROPHONE TO IMPROVE DETECTION OF SPEAKER

(71) Applicant: Sony Interactive Entertainment Inc., Tokyo (JP)

(72) Inventors: Lakshmish Kaushik, San Mateo, CA (US); Xiaoyong Ye, San Mateo, CA (US); Mario Sarria, San Mateo, CA (US); Koichi Obana, San Mateo, CA (US); Sergey Bashkirov, San Mateo, CA (US); Michael Prosinski, San Mateo, CA (US)

(21) Appl. No.: 18/956,350

(22) Filed: Nov. 22, 2024

(51) Int. Cl. A63F 13/424; A63F 13/55; G06F 40/30; G10L 15/26

(52) U.S. Cl. CPC A63F 13/424; A63F 13/55; G06F 40/30; G10L 15/26; A63F 2300/6072

(57) ABSTRACT

Non-player characters (NPC) in a computer game may be controlled using context in the form of player statements from the game engine to an LLM to drive NPC dialog and control NPC actions. Imperative statements are executed by game engine, and the result of this execution plus the original player request are converted to plain text description and injected back into the NPC dialog to ensure the NPC remains within defined bounds.

### FIELD

The present application relates generally to language model control over non-player characters by means of bi-directional data flow and semantic analysis.

### BACKGROUND

Video games have become sophisticated and complex, in particular the interaction between a player-controlled character and non-player characters (NPC) who may represent enemies in the game or other game characters. Controlling such NPC may be effected using machine learning-based agents.

### SUMMARY

As understood herein, not only NPC action but also NPC dialog may be controlled based on semantic analysis of player speech, which is sent from the game engine to a machine learning (ML) model in a bidirectional loop to ensure NPC speech and behavior remain “in bounds”.

Accordingly, an apparatus includes at least one processor system configured to receive data representing speech from a player of a computer game, and generate dialog of at least one non-player character (NPC) in the computer game based at least in part on the data representing speech from the player.

In some embodiments the processor system can be configured to control action of the NPC based at least in part on the data.

In example embodiments the processor system may be configured to convert utterances of the player to text to determine whether the player has uttered an imperative statement, and responsive to determining that the player has uttered an imperative statement, execute a game engine to attempt to execute an action represented by the imperative statement. The processor system can be further configured to generate a description of a result of the attempt to execute the action. Moreover, the processor system may be configured to inject the description of the result back into the computer game for action control of the NPC. In example implementations, the processor system may be configured to use the description of the result to generate dialog for the NPC, and play the dialog during play of the computer game.

If desired, the processor system additionally can be configured to, responsive to determining that the player has uttered a non-imperative statement, generate NPC dialog based on the non-imperative statement, and play the dialog during play of the computer game.

In another aspect, an apparatus includes computer memory that is not a transitory signal and that in turn includes instructions executable by at least one processor system to semantically analyze statements from a player of a computer game using one or more language models to generate dialog of a non-player character (NPC) of the computer game. The instructions also are executable to execute imperative statements from the player using a game engine associated with the computer game. Further, the instructions are executable to convert into text a result of executing imperative statements from the player to generate NPC dialog to ensure the NPC dialog remains synchronized with behavior of the NPC.

In another aspect, a method includes controlling action of a non-player character (NPC) in a computer game, and controlling dialog in the NPC. Both controlling steps are executed using artificial intelligence (AI) based on NPC speech generation based on context, semantic analysis of player statements to convert to machine readable format, which a game engine executes and also sends text of to a language model to give the model context.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example system consistent with present principles;

FIG. 3 illustrates example logic in example flow chart format for training a machine learning (ML) model to identify imperative statements;

FIG. 4 illustrates example logic in example flow chart format for training a ML model to generate non-player character (NPC) dialog;

FIG. 5 illustrates example logic in example flow chart format for training a ML model to generate descriptions of execution results;

FIG. 6 illustrates example logic in example flow chart format for using one or more ML models to generate NPC dialog based on player utterances;

FIG. 7 illustrates a first example NPC dialog based on a failed execution of an imperative statement from the player;

FIG. 8 illustrates a second example NPC dialog based on a successful execution of an imperative statement from the player;

FIG. 9 illustrates a third example NPC dialog based on a non-imperative statement from the player;

FIG. 10 illustrates example logic in example flow chart format for training a ML to solve a problem it otherwise cannot solve using conventional input-output training sets;

FIG. 11 illustrates example logic in example flow chart format for training a ML to solve a specific problem of semantic analysis; and

FIG. 12 illustrates example logic in example flow chart format for using a ML to generate NPC dialog.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

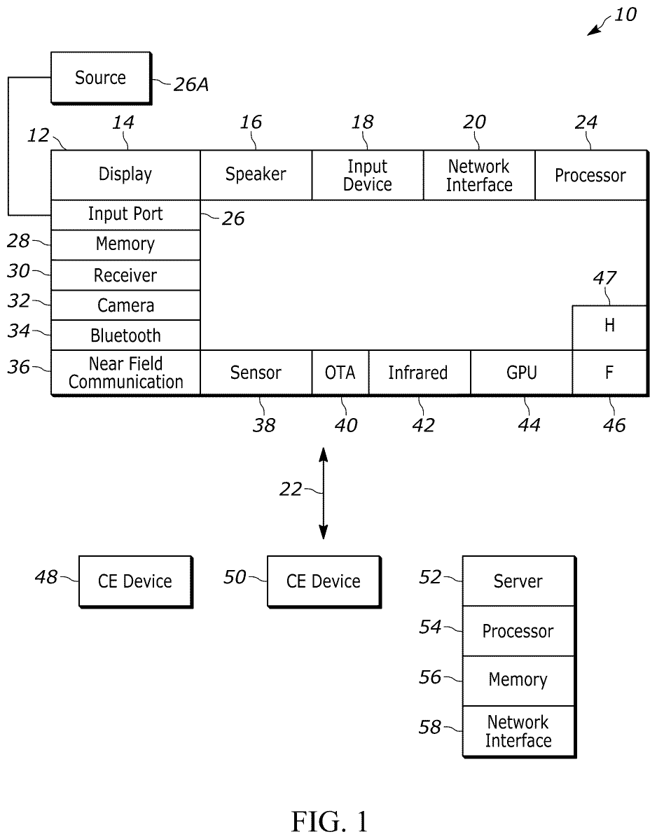

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) and other large language models (LLM) and more generally generative models (GM) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

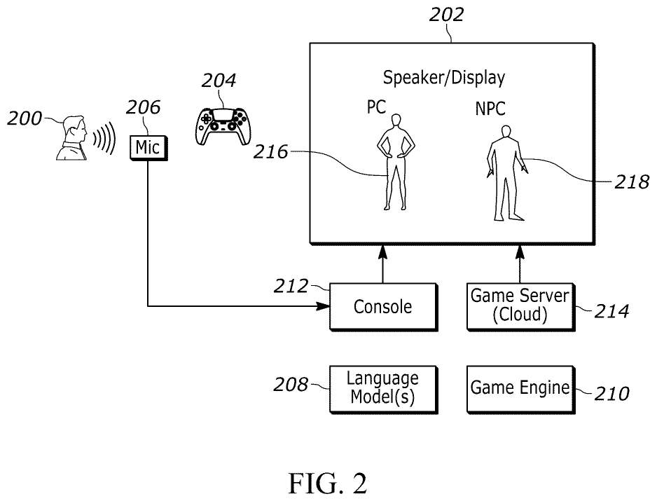

Refer now to FIG. 2. A person 200 can control a computer game presented on an AV display 202 using a computer game controller 204. The player 200 can speak and utterances from the player are picked up by one or more microphones 206. The speech may be provided e.g., via wireless link, to one or more language models 208 executed by one or more sources of the computer game by executing a game engine 210. The one or more sources may include a computer game console 212 and/or a cloud game server 214.

As shown in FIG. 2, an example computer game may include a player character (PC) 216 whose actions are controlled by the player 200 through manipulation of the controller 204 and/or in response to vocal commands spoken by the person 200. The game also may include a non-player character (NPC) 218 whose actions and speech are controlled by the game engine 210 based on output of the one or more language models 208. The one or more language models 208 may be implemented by generative models such as large language models (LLM).

As detailed further herein, statements from the player 200 are semantically analyzed by the one or more language models 208 to drive the dialog of the NPC 218. Imperative statements are executed by the game engine 210. The result of the execution plus the original player statements are converted to plain text description and injected back into dialog to generate a next NPC statement to ensure the NPC dialog remains within defined bounds. A behavior tree describing the actions of the NPC matches the state of the language model so that the behavior of the NPC remain synchronized with the dialog generated by the language model. NPC action execution and decision making happens on game engine side.

Thus, as described below both the actions and the dialog of the NPC 218 are controlled using artificial intelligence (AI) based on three tasks: speech generation based on context, semantic analysis of player statements to convert to machine readable format, which the game engine executes and also sends text of to the language model to give the model context, and bidirectional data flow between the game engine and language model.

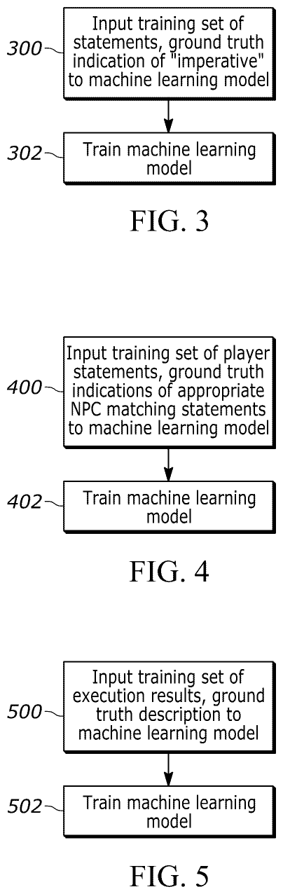

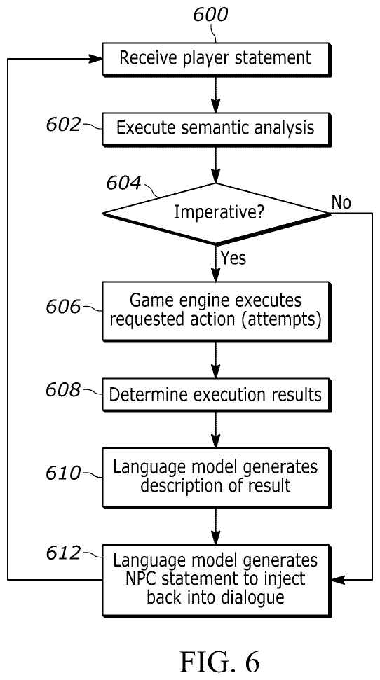

FIGS. 3-5 illustrate training logic for separate language models to perform distinct tasks in FIG. 6, it being understood that a single model may be trained on all of the data shown in FIGS. 3-5 if desired. Commencing at state 300 a training set of data is input to a ML model (such as an LLM) to train the model at state 302. The training set may include samples of statements along with a ground truth indication of whether the statements are imperative statements.

Turning to FIG. 4, commencing at state 400 a training set of data is input to a ML model (such as an LLM) to train the model at state 402. The training set may include samples of player statements and ground truth indications of appropriate matching NPC statements.

FIG. 5 illustrates that at block 500 a training set of data is input to a ML model (such as an LLM) to train the model at state 502. The training set may include samples of imperative statement execution results along with ground truth descriptions of the results. The trained ML model(s) are then used as described in FIG. 6.

Now refer to FIG. 6. Commencing at state 600, utterances of the player 200 shown in FIG. 2 are received. The utterances may be converted to text for semantic analysis at state 602 to determine whether the player has uttered an imperative statement at state 604. If so, the logic moves to state 606 in which the game engine attempts to execute the requested action.

The results of the execution are then determined at state 608, e.g., true/false (whether the action was or was not successfully executed). The language model generates a description of the result of execution at state 610, which is injected back into the game for further action control of the NPC. State 612 indicates that a next NPC dialog snippet is generated based in part on the execution result description from state 610 to cause the NPC to speak during game play. The logic then loops back to state 600 to receive the next player statement.

Responsive to determining at state 604 that the player's utterance was not an imperative statement, the logic may move directly to state 612 to generate NPC dialog based on the player's statement from state 600.

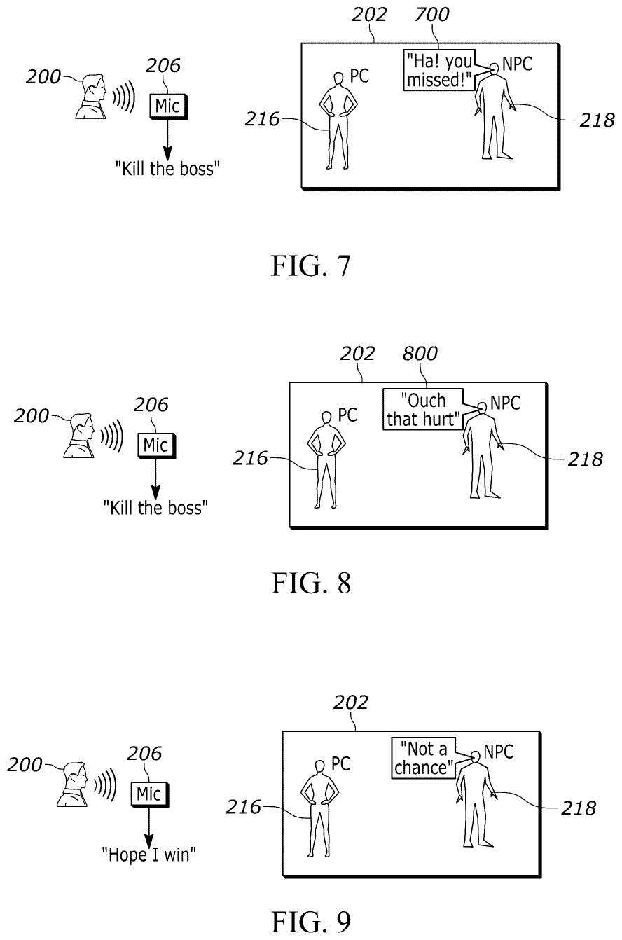

FIGS. 7-9 illustrate further. In FIG. 7, the player has uttered an imperative statement, in the example shown, “kill the boss”. However, FIG. 7 assumes that this action was not successfully executed, and the example dialog 700 of the NPC 218 (“ha you missed”) reflects this.

On the other hand, FIG. 8 assumes that the action precipitated by the player's imperative statement was successfully executed, and the example dialog 800 of the NPC 218 (“ouch that hurt”) reflects this.

While FIGS. 7 and 8 assume imperative utterances from the player 200, FIG. 9 assumes a non-imperative utterance, in the example shown, “hope I win”. The example dialog 900 of the NPC 218 (“not a chance”) reflects the player's non-imperative utterance.

The techniques above reduce “hallucination” of a model in generating inappropriate dialog because decisions for the requests are made by the game engine rather than the language model. Due to that, the command execution and dialog direction is in full control of the game developer. Statements are generated based on the command execution by the game engine and fed to the language model, which preserves the logical flow of the dialog based on the command execution results provided to it by the game.

In this way, the game engine advantageously can receive and execute player commands converted to a machine-friendly format, and the language model is made aware of the actions taken by the NPC because of the responses the game engine sends back to the language model. Also, the responses the language model gives to the player in the form of NPC dialog are based on the command execution results converted to a plain human-friendly format and cannot deviate from the game scenario because they are based on the injected results from the game. This forces the language model to stay on track with game execution.

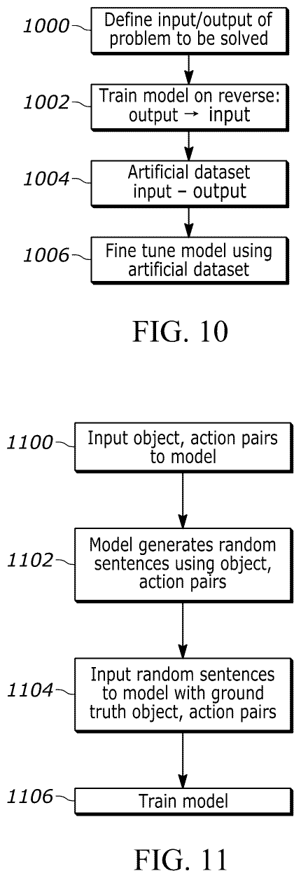

FIGS. 10-12 show a generalized and then a specific technique for enabling a language model to solve a problem it otherwise could not solve, using a technique in which data is generated in reverse order. Normally, training datasets consist of input->output pairs. The technique described herein enables a model to easily solve the reversed problem of output->input to generate an artificial dataset and then fine tune training on the artificial dataset. After training the model can solve the original input->output problem with high accuracy.

FIG. 10 illustrates. Commencing at state 1000, an input->output problem is defined, with the output being the problem to be solved. Proceeding to state 1002, the model is trained on the reverse dataset, namely, output->input to generate an artificial dataset at state 1004. The artificial dataset is then fed back into the model at state 1006 to fine tune the training of the model.

FIG. 11 illustrates a specific example germane to the techniques of FIGS. 2-9. Recognizing that it is difficult to train a model to extract the object and action from a random sentence, at state 1100 object, action pairs are input to the model to allow it to generate, at state 1102, random sentences from those pairs (which is an easier problem than identifying the object and action in the first place). At state 1104 the model then receives back its own random sentences with the now-known ground truth of what are the object and action words in those sentences to fine tune training of the model at state 1106. Note the same technique may be employed using images or behaviors of the NPC.

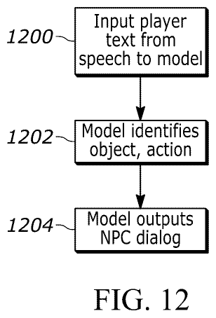

FIG. 12 illustrates use of a model trained as described. Commencing at state 1200, player 200 speech is received and input in text or audio form to the model, which identifies the object and action in the speech at state 1202. The model uses the identified object and action to generate NPC 218 dialog at state 218.

While the particular embodiments are herein shown and described in detail, it is to be understood that the subject matter which is encompassed by the present invention is limited only by the claims.

What is claimed is:

1. An apparatus comprising:
at least one processor system configured to:
receive data representing speech from a player of a computer game; and
generate dialog of at least one non-player character (NPC) in the computer game based at least in part on the data representing speech from the player.

2. The apparatus of claim 1, wherein the processor system is configured to:
control action of the NPC based at least in part on the data.

3. The apparatus of claim 1, wherein the processor system is configured to:
convert utterances of the player to text to determine whether the player has uttered an imperative statement;
responsive to determining that the player has uttered an imperative statement, execute a game engine to attempt to execute an action represented by the imperative statement.

4. The apparatus of claim 3, wherein the processor system is configured to:
generate a description of a result of the attempt to execute the action.

5. The apparatus of claim 4, wherein the processor system is configured to:
inject the description of the result back into the computer game for action control of the NPC.

6. The apparatus of claim 5, wherein the processor system is configured to:
use the description of the result to generate dialog for the NPC; and
play the dialog during play of the computer game.

7. The apparatus of claim 3, wherein the processor system is configured to:
responsive to determining that the player has uttered a non-imperative statement, generate NPC dialog based on the non-imperative statement; and
play the dialog during play of the computer game.

8. An apparatus comprising:
computer memory that is not a transitory signal and that comprises instructions executable by at least one processor system to:
semantically analyze statements from a player of a computer game using one or more language models to generate dialog of a non-player character (NPC) of the computer game;
execute imperative statements from the player using a game engine associated with the computer game;
convert into text a result of executing imperative statements from the player to generate NPC dialog to ensure the NPC dialog remains synchronized with behavior of the NPC.

9. The apparatus of claim 8, comprising the at least one processor system.

10. The apparatus of claim 8, wherein the instructions are executable to:
control action of the NPC based at least in part on the data.

11. The apparatus of claim 8, wherein the instructions are executable to:
determine whether the player has uttered an imperative statement;
responsive to determining that the player has uttered an imperative statement, execute the game engine to attempt to execute an action represented by the imperative statement.

12. The apparatus of claim 11, wherein the instructions are executable to:
generate a description of a result of the attempt to execute the action.

13. The apparatus of claim 12, wherein the instructions are executable to:
inject the description of the result back into the computer game for action control of the NPC.

14. The apparatus of claim 13, wherein the instructions are executable to:
use the description of the result to generate dialog for the NPC; and
play the dialog during play of the computer game.

15. The apparatus of claim 8, wherein the instructions are executable to:
responsive to determining that the player has uttered a non-imperative statement, generate NPC dialog based on the non-imperative statement; and
play the dialog during play of the computer game.

16. A method, comprising:
controlling action of a non-player character (NPC) in a computer game;
controlling dialog in the NPC;
wherein the controlling steps are executed using artificial intelligence (AI) based on NPC speech generation based on context, semantic analysis of player statements to convert to machine readable format, which a game engine executes and also sends text of to a language model to give the model context.

17. The method of claim 16, comprising:
determining whether the player has uttered an imperative statement;
responsive to determining that the player has uttered an imperative statement, executing the game engine to attempt to execute an action represented by the imperative statement.

18. The method of claim 17, comprising:
generating a description of a result of the attempt to execute the action.

19. The method of claim 18, comprising:
injecting the description of the result back into the computer game for action control of the NPC.

20. The method of claim 19, comprising:
using the description of the result to generate dialog for the NPC; and
playing the dialog during play of the computer game.
